(19) United States
(12) Patent Application Publication
(10) Pub. No.: US 2012/0166261 A1
(43) Pub. Date: Jun. 28, 2012

(54) METHOD AND SYSTEM FOR DYNAMIC COUPON SHARING

(75) Inventors: Umashankar Velusamy, Tampa, FL (US); Paul T. Schultz, Colorado Springs, CO (US)

(73) Assignee: VERIZON PATENT AND LICENSING INC., Basking Ridge, NJ (US)

(21) Appl. No.: 12/978,980

(22) Filed: Dec. 27, 2010

(51) Int. Cl. G06Q 30/00

(52) U.S. Cl. 705/14.16; 705/14.26

(57) ABSTRACT

An approach for enabling a purchaser to dynamically direct retail offers to peers within their social network based on a purchase transaction is described. A deal sharing platform maintains a list of one or more items and associated cost information corresponding to a financial transaction conducted with a vendor system. The deal sharing platform retrieves from the list an offer relating to the items based on the transaction and a selection criteria for a predetermined group of one or more recipients specified by a user. An option to distribute the offer to the predetermined group is then initiated for presentation on a communication device of the user.

### BACKGROUND INFORMATION

Service providers are continually challenged to deliver value and convenience to consumers by providing compelling network services and advancing the underlying technologies. One area of interest has been the development of services and technologies for enabling shared or group based interaction among computing devices, such as smartphones, netbooks, etc. Traditional social networking tools and applications allow peers, such as friends, family members and co-workers, to exchange data, to communicate with one another, to participate in shared games and web applications, and to execute other features by way of their computing devices. Many retailers, including vendors and service providers, recognize the tremendous opportunity associated with social networking, including the ability to direct targeted advertisements and offers to groups of people (consumers) based on their common interests. However, the communication process engaged in by the purchaser with their peers is divorced from, or incidental to the purchase process.

Based on the foregoing, there is a need for better integrating transactions and communications.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a system for enabling a purchaser to dynamically direct retail offers to peers based on a purchase transaction, according to one embodiment;

FIGS. 1B-1D are diagrams of workflow processes executed by a purchaser, one or more peers and a retailer with respect to the system of FIG. 1, according to various embodiments;

FIG. 2 is a diagram of a deal sharing platform for enabling a purchaser to share retail offers with peers based on a purchase transaction, according to one embodiment;

FIGS. 3A-3D are flowcharts of a process for directly sharing offers with peers, according to various embodiments;

FIGS. 4A-4C are diagrams of a user interface for enabling device users to direct and receive retail offers among peers based on a purchase transaction, according to various embodiment;

FIG. 5 is a diagram of a user interface for configuring a device to direct or receive retail offers among peers based on a purchase transaction, according to one embodiment;

FIG. 6 is a diagram of a computer system that can be used to implement various exemplary embodiments; and

FIG. 7 is a diagram of a chip set that can be used to implement an embodiment of the invention.

### DESCRIPTION OF THE PREFERRED EMBODIMENT

An apparatus, method and software for enabling a purchaser to direct retail offers to peers within their social network based on a purchase transaction is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

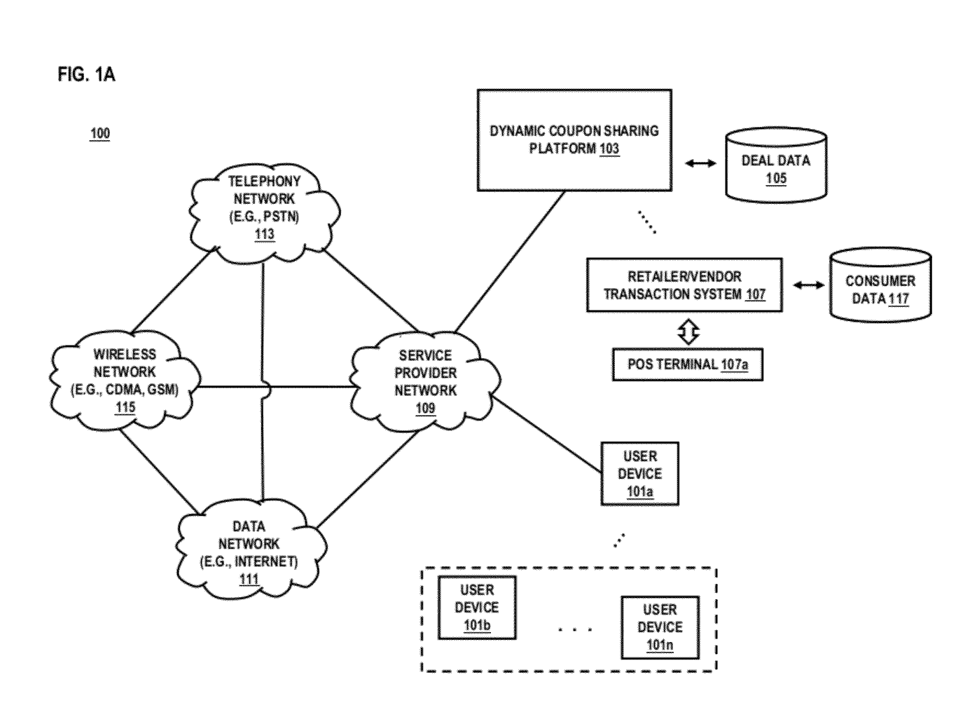

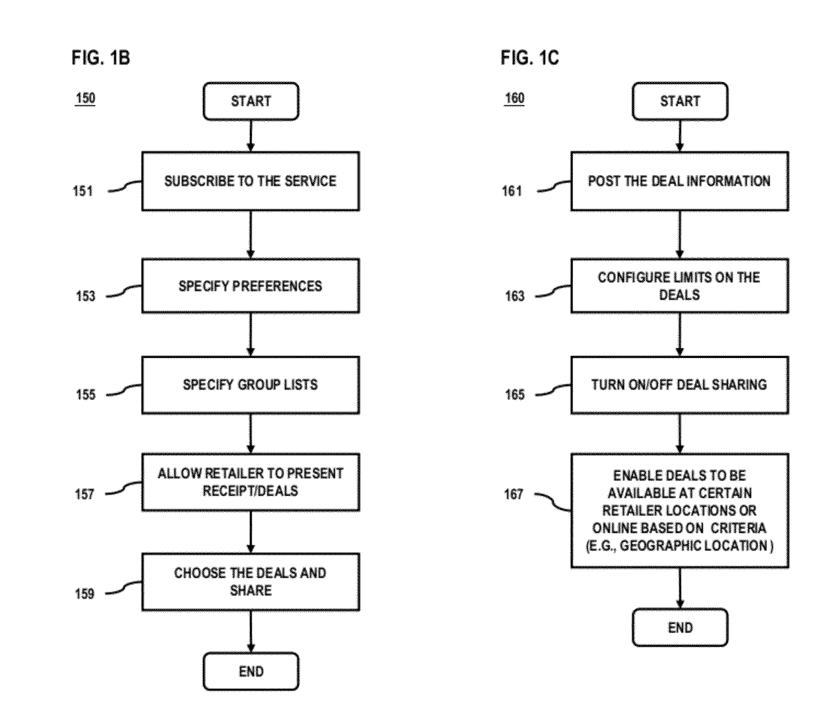

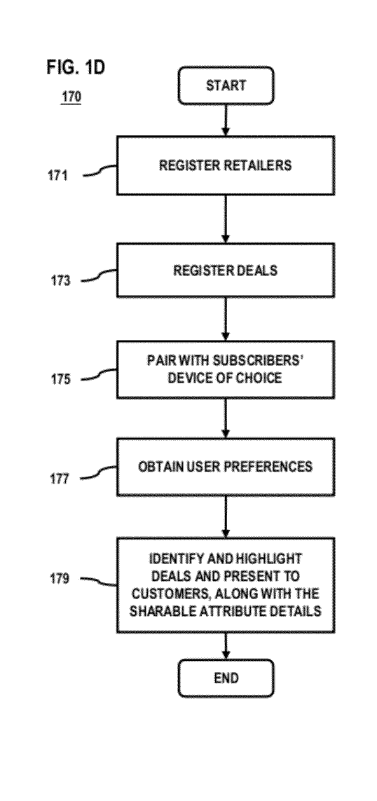

FIG. 1A is a diagram of a system for enabling a purchaser to dynamically direct retail offers to peers based on a recent purchase transaction, according to one embodiment. For the purpose of explanation, system 100 is shown to include one or more user devices 101a-101n (e.g., mobile device, smart phone, netbook, tablet, laptop, set-top box, or any communications enabled computing device) that are configured to communicate with each other to enabling the sharing or receiving of deals and offers from a supplier of goods and/or services (e.g., merchants, retailers, wholesalers, etc.). These deals are made available by a dynamic coupon (or deal) sharing platform 103, and according to certain embodiments, can be provided in the form of a physical and/or electronic coupon. In one embodiment, the platform 103 is maintained by a service provider (e.g., a wireless communication company) as a hosted or subscription based service made available to users of devices 101a-101n through a service provider network 109. By way of example, the coupon sharing platform 103 enables the service provider, individual users of devices 101a-101n subscribed with the service provider, and a network of retailers/vendors managed by a retailer/vendor transaction system 107 to exchange information (e.g., coupon information) regarding deals of potential interest to the users.

In certain embodiments, a “deal” pertains to an offer, incentive, discount, reward, or any other program provided by a supplier (e.g., retailer, merchant, vendor, etc.) for encouraging or enticing a user to purchase a product. By way of example, information representative of or pertaining to a deal may include a discount percentage or price reduction, details regarding the product or service being offered, details regarding the retailer or vendor, expiration dates, participating store locations, a discount code, etc. In addition to offering deals as a means of driving sales, many retailers, vendors and service providers also recognize the impact that social networking can play in the marketing and advertising process. For example, some retailers will direct targeted advertisements and offers to groups of people (consumers) who interact by way of a social networking site based on their determined interests and online interaction patterns. Under this approach, if peers within the social network communicate regularly about video games, for example, the social networking interface may be configured to present more advertisements by video game retailers and vendors. As another approach, retailers and vendors may also develop schemes for inviting commentary, feedback and recommendations regarding their products to be shared among, thereby leveraging the influence of the peers within the social network or generating a word-of-mouth campaign.

Currently, however, attempts at target marketing, viral advertising promotion or word-of-mouth marketing through traditional social networking means do not leverage point-of-sale communication opportunities. Retailers have no way of enabling purchasers of their products to immediately direct offers and incentives to peers within their social network at the time of purchase, i.e., when consumers are most excited about their purchases. While a purchaser of a product may utilize social networking or other communication mediums to share details about the purchase with their peers, this type of interaction is not a natural, built-in part of the transactional process. At best, the purchaser is relegated to recounting their purchase experience after the fact, if they do so at all, with no opportunity for the retailer to encourage such communication. Hence, there is no convenient, automated means by which purchasers can immediately share purchase details with friends. Furthermore, there is no platform from which retailers can incent and manage such behavior on the part of their purchasers.

To address this issue, system 100 of FIG. 1 enables users of computing devices, such as mobile phones and smartphones to readily communicate purchase details with peers as part of the transactional process. In addition, the system 100 provides an approach of presenting deals to the purchaser, the peers selected by the purchaser, or both as a means of generating word-of-mouth or target marketing on behalf of the retailer. By way of example, a coupon sharing platform 103 interacts with a retailer/vendor transactional system 107 to enable deals made available by a retailer to be shared with the purchaser. In addition, the coupon sharing platform 103 presents various interfaces and capabilities for enabling the purchaser to dynamically share these deals with their friends. Under this scenario, when a user of device 101a purchases products, goods or services from one or more retailer/vendors via a point-of-sales (POS) terminal 107a, the purchaser is automatically notified via the coupon sharing platform 103 of any deals available for sharing with peers at their respective user devices 101b-101d. The notification may be received as a short message service (SMS), e-mail, a web-service based message or a as a pop-up message invoked by a deal application (not shown) operable on the user device 101a. The coupon information can be distributed to the peers at any type of user device that is capable of supporting the particular format of the notification.

It is noted that user devices 101a-101n may be any type of mobile terminal, fixed terminal, or portable terminal including a mobile handset, station, unit, device, multimedia computer, multimedia tablet, Internet node, communicator, netbook, desktop computer, laptop computer, Personal Digital Assistants (PDAs), smartphone or any combination thereof. It is also contemplated that the user devices 101a-101n can support any type of interface for supporting the presentment or exchanging of data. In addition, user devices 101a-101n may facilitate various input means for receiving and generating information, including touch screen capability, keyboard and keypad data entry, voice-based input mechanisms, accelerometer (e.g., shaking the mobile device), and the like. Any known and future implementations of user devices 101 are applicable. It is noted that in certain embodiments user devices 101a-101n may be configured to establish peer-to-peer communication sessions with each other using a variety of technologies—i.e., near field communication (NFC), Bluetooth, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

The coupon sharing platform 103 stores information regarding the various deals made available by the retailer/vendor to the purchaser and their peers in a deal database 105. When a purchaser is identified at a POS terminal 107, deal data of interest to the purchaser and relative to the retailer (or affiliates thereof) from which the purchase transaction is associated may be presented to the user device 101a; thus integrating peer-to-peer communication (e.g., social networking) into the transactional process. For example, deal data may be presented to a user to reflect details of an entire purchase transaction—i.e., an itemized bill may be presented to the user that lists all the items purchased, discounts or special offers applied to or available with respect to those items, highlighted formatting and/or visual indicators for conveying the quality of the deal as perceived by the user, and other such information.

As a further example, when a user is subscribed to and configured with the dynamic coupon (or deal) sharing platform 103 to receive deals at or above a specified percentage off the purchase price, information displayed to the user device may include:
Format 1—for users wanting deal data based on a specific percentage discount off the purchase price:
   Bolo Shirt—$5
   Tim Tim One Personal Navigator—$20 ***With 80% Off Coupon***
   HopFrog Reader—$30
   Total—$55
Format 2—for users wanting deal data based on the number of people they can share the deal with:
   Bolo Shirt—$5
   Tim Tim One Personal Navigator—$20 ***80%—Share Up to 5***
   HopFrog Reader—$30
   Total—$55
Format 3—for users wanting deal data regarding on incentives they may receive for purchases made by those they share the deal with—i.e., number of people who should purchase the same item so the item becomes free for the user:
   Bolo Shirt—$5
   Tim Tim One Navigator—$20 ***80%—10 Until Free***
   Tim Tim One Navigator Stand—$4 ***80%—10 Until 50% off***
   HopFrog Reader—$30
   Total—$59

As presented in the various examples above, deal data 105 may be presented to the user interface of the user device 101a in various forms corresponding to the requirements, characteristics and criteria established by the user. In certain embodiments, the deal data may also be presented along with various capabilities for enabling the purchaser to forward or share deal data 105 with friends, family members and other peers. As discussed more fully with respect to Tables 1 and 2, the purchaser can also configure their own criteria (e.g., threshold setting) for affecting how they are notified of deals by the platform 103 or peers. For example, only present deal data that meets threshold requirements, notification of incentives resulting from acceptance of a shared deal by a friend, etc.

In certain embodiments, the retailer/vendor transaction system 107 is an operations management tool maintained by the retailer/vendor. By way of example, the system 107 may include one or more servers, computing agents, customer relationship management tools, software utilities, databases and corresponding data sets and other resources for supporting the operations of the retailer/vendor. The system 107 may also be configured to ensure proper management of online or in-store purchase transactions engaged by customers, as well as for ensuring proper reconciliation of purchase transactions against inventory, production, manufacturing, delivery, supply chain and other needs. In certain instances, the retailer/vendor transaction system 107 may provide for the interconnection of resources across geographic locations (e.g., multiple different retail stores), the interaction of multiple retailers (e.g., Retailer A in partnership with Retailer B) and the like. By way of this approach, deal data 105 from multiple different retailers/vendors on a wide variety of products, goods and services may be maintained by the coupon sharing platform 103.

While implementations may vary, for the purpose of illustration, a point-of-sales (POS) terminal 107a may be presented to a purchaser (customer) as an interface for enabling purchase transactions to be handled in connection with the retailer/vendor system 107. It is noted that while the retailer/vendor transaction system 107 may not be maintained by the service provider, the coupon sharing platform 103 may be configured to enable interaction with the system 107. This interaction may be prearranged by the retailer/vendor and the service provider, so as to facilitate data sharing between respective parties for generation of various incentives and offers to mutual subscribers/customers. By way of example, a bar code or other identifier provided as deal data to a user device may be presented to (e.g., scanned by) the POS terminal 107a for enabling activation of a discount, incentive or other benefit. The bar code or other identifier may be specifically assigned to a particular device user, including peers, for enabling the platform 103 to track deal usage.

In one embodiment, POS terminal 107 is a computerized device for conducting a financial or payment transaction in relation to a product or service purchase. POS terminal 107 can include, for example, functions for recording and tracking customer orders, processing credit and debit cards (e.g., featuring built-in payment acceptance and processing systems) and managing inventory and deliveries. In addition, POS terminal 107 can connect to other systems and devices over a communication network, including those systems and devices directly within the environment of its operation (e.g., other POS systems or computers within the retailer/vendor location) as well as external systems. It may also be configured to enable communication with a user device 101a using near field communication, Bluetooth, ZigBee, or other wireless communication technologies. Of note, the POS terminal 107a may be implemented as a physical device resident at the location of a retailer, as an online transactional platform offered by the retailer/vendor transaction system 107, or a combination thereof. In the latter example, the user is able to engage purchase and payment transactions with the retailer by way of a web portal or browser application at a user device 101a.

To facilitate purchase transactions, the retailer/vendor transaction system 107 also maintains consumer data 117 regarding the various customers who make purchases from the retailer or vendor. The consumer data 117 pertaining to a given purchaser may be recalled or referenced by the POS terminal 107a in order to facilitate the purchase process. It is noted that the consumer data 117 may be used to identify the purchaser at the time of transaction for facilitating deals. This may include recalling data for the purchaser by scanning a frequent shopper card to which the customer is linked, associating a credit card, debit card or check processed by the transaction system 107 at the time of purchase with the customer, entering a customer identifier or phone number into a user interface of the POS terminal, by scanning a certificate or coupon code (e.g., bar code), via wireless communication with the customer's mobile device, or some other means. Data maintained as customer data 105, may therefore include the name of the purchaser, the date of their last transaction, discounts for which they qualify or have taken advantage of in the past, shopping statistics and habits, affiliated family members linked to the same account, address information, product preferences, etc. In one embodiment, respective to the sharing of deals by the purchaser with peers, the customer data may also include a phone number associated with the customer's user device 101a along with details regarding the service provider (e.g., phone number or internet service provider) to which they are affiliated.

FIGS. 1B-1D are diagrams of workflow processes executed by a purchaser, one or more peers and a retailer with respect to the system of FIG. 1, according to various embodiments. In FIG. 1B, process 150 pertains to a subscriber (purchaser) to the deal sharing service. In workflow steps 151-155 respectively, the purchaser subscribes to the service, specifies their deal preferences and also predetermines (selects) the contacts or groups they want to share deal data (e.g., coupon information) with. Per step 157, the purchaser also configures their user device 101a to allow retailer(s) to present a transaction receipt and associated deals. In another step 159, the purchase chooses the deals of interest to them and sends the deals to their predetermined contacts (peers).

In FIG. 1C, process 160 pertains to a service provider of the deal sharing service. In workflow steps 161-163 respectively, the service provider posts the deal data 105 as provided in connection with one or more retailers, configures limits on the deals and enables or disables deal sharing in accordance with a subscriber or peer profile. In step 165, the process 160 permits the activation or deactivation (ON/OFF) of the deal sharing function. Per step 167, the service provider also enables deals to be available at certain retailer locations or online based on various selection criteria (e.g., geographic location).

In FIG. 1D, process 170 pertains to a retailer that offers deals by way of the deal sharing service. In workflow steps 171-175 respectively, the retailer registers with the deal sharing service (e.g., via platform 103), registers one or more deals as deal data 105 and pairs with a user device 101 of a subscriber to the coupon sharing platform 103. Per step 177, the retailer also obtains user preferences as specified by the subscriber and/or one or more peers. In another step 179, the retailer identifies and highlights deals and presents this data to user devices 101, along with sharable attribute details (e.g., one or more action buttons, a map to the nearest retail location based on the user's location, data entry fields or selection options).

In certain embodiments, user devices 101a-101n, the coupon sharing platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, Internet protocol multimedia subsystem (IMS), or other suitable infrastructure to support control and signaling functions.

According to exemplary embodiments, one or more of the user devices 101a-101n may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smartphone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

In effect, the platform 103 can interact with any of these user devices 101a-101n to convey the coupon information to the recipients. Exemplary components of platform 103, according to one embodiment, are described below.

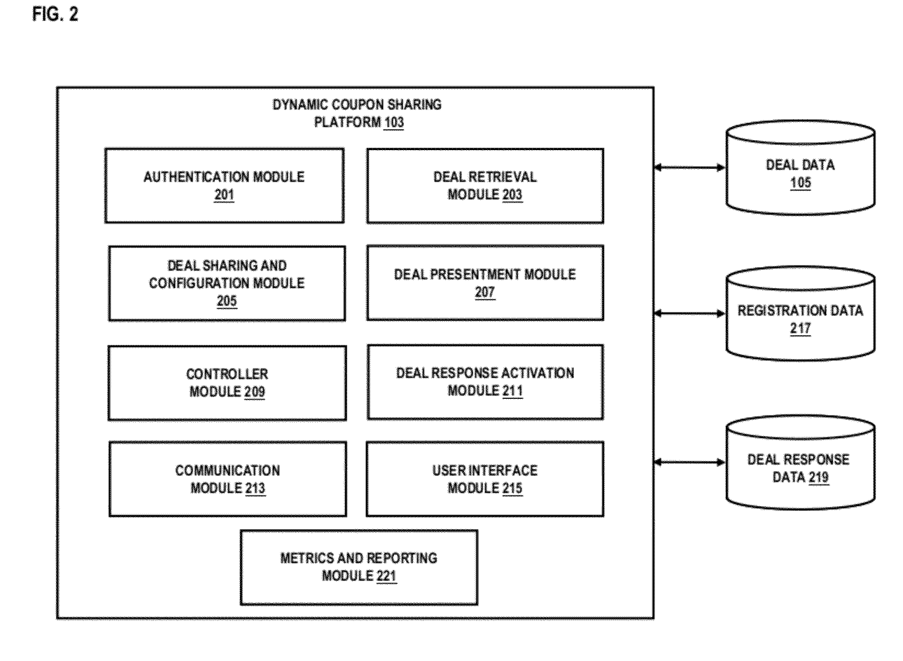

FIG. 2 is a diagram of a coupon sharing platform for enabling a purchaser to share retail offers with peers based on a purchase transaction, according to one embodiment. The coupon sharing platform 103 includes various executable modules for performing one or more computing, data processing and network based instructions that in combination provide a means of enabling the sharing deals of deals by retailers and device users alike. Such modules can be implemented in hardware, firmware, software, or a combination thereof. By way of example, the coupon sharing platform 103 may include an authentication module 201, deal retrieval module 203, deal sharing and configuration module 205, deal presentment module 207, controller module 209, deal response activation module 211, communication module 213 and user interface module 215. In addition, the coupon sharing platform 103 also maintains deal data 105 as received from various retailers and vendors (e.g., via a retailer/vendor transaction system 107), registration data 217 pertaining to the various subscribers to the coupon sharing platform 103 by way of the service provider, and deal response data 219 for providing feedback regarding various peers in response to a shared deal. According to one embodiment, a metrics and reporting module 221 is provided to track the effectiveness of the deal sharing feature for the subscribers, and to generate various reports relating to such feature.

In one embodiment, an authentication module 201 authenticates users and user devices 101a-101n for interaction with the coupon sharing platform 103. By way of example, the authentication module 201 receives a request from a user of a device 101 to subscribe to the deal sharing service for enabling receipt of deal data 105 during purchase transactions. The subscription process may include enabling communication between the user device 101 and a POS terminal 107a. Other settings may include specifying the method of communicating deals to the user device 101, such as e-mail, short messaging service (SMS) or as a web-based communication. In certain instances, the initial authentication process may also involve the uploading of a deal sharing application (not shown)—i.e., for enabling deal sharing features and controls—to respective user devices 101a-101n.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the platform 103 (e.g., as enabled by user interface module 215). Alternatively, the login process may be performed through automated association of profile settings maintained as registration data 217 with an identification signal generated by an active device, i.e., a carrier detection signal, IP address, mobile directory number (MDN), subscriber identity module (SIM) (e.g., of a SIM card), radio frequency identifier (RFID) tag, or customer identifier value determined via a POS terminal 107a.

By way of example, the authentication module 201 receives messages from a POS terminal 107a of the retailer/vendor transaction system 107 indicating a customer that is or has engaged in a purchase transaction. This message may be received from the POS terminal 107a based on the detection of a frequent shopper card registered to the customer, entry of a special discount or coupon code associated exclusively with the customer, processing of a credit or debit card of the user, entry of a phone number or customer identifier, or a combination thereof. It is noted, therefore, that the authentication process of module 201 may include determining if the customer has registered to receive sharable deal data 105. In addition, the authentication module 201 also receives messages from a POS terminal 107a of the retailer/vendor transaction system 107 indicating a customer that is or has engaged in a purchase transaction. This message may be received from the POS terminal 107a based on the detection (scanning) of a frequent shopper card registered to the customer, entry of a special discount or coupon code associated exclusively with the customer, processing of a credit or debit card of the customer, entry of a phone number, e-mail address or customer identifier, or a combination thereof. As part of the authentication process, therefore, the authentication module 201 checks to see if the customer has registered to receive sharable deals based on their purchase transaction.

In one embodiment, the deal retrieval module 203 retrieves deal data 105 from the retailer/vendor transaction system 107. As mentioned previously, the deal data 105 pertains to the various deals, incentives and special offers on products and services of given retailers. By way of example, the deal data 105 may include specific reference to product codes and identifiers (UPCs), manufacturer codes, discount levels or pricing tier information, etc. In addition, the deal data 105 may specify terms, conditions, purchase pricing, product information (audio, textual, visual) and other data useful for informing people about the deal or for inducing sharing and participation in the deal, etc. It is noted that deal data 105 may be retrieved and stored by the deal retrieval module 203 on a periodic basis from the plurality of vendors and retailers of which the service provider is affiliated. As will be discussed more fully, the particular set of deal data made available for presentment at user devices 101a-101n depends on criteria or preferences as established by the purchaser or peers of said purchaser, as well as rules and settings of the retailer/vendor.

In one embodiment, the peer sharing and configuration module 205 retrieves information regarding the peers who are chosen by a purchaser to receive information regarding a particular deal. The peers, who in certain instances are also subscribed to the coupon sharing platform 103, may be predetermined for association with the purchaser by way of their profile which is maintained as registration data 217. Under this approach, deals may be automatically shared with the purchaser's favorites, or configured to be shared by an order of priority or other arrangement. Alternatively, peers may be indicated by the purchaser through a selection process at their user device 101a, then shared with the peer sharing module 205 for indicating which peer user devices 101b-101d the data should be directed to. Regardless of the approach, the peer sharing module 205 refines the profile of the purchaser (e.g., the registration data 217) accordingly in response to the addition or selection of peers designated for receiving deal data 105.

By way of example, the deal sharing module 205 maintains a queue of peers selected for receipt of the deal. Peers may be selected by way of a contact management application or social networking application operable in connection with the purchaser's user device 101a. The queue ensures that the message for conveying the deal data 105 is sent to all of the peers uniformly by the communication module 213. In certain embodiments, the peer sharing module 205 may also enable the creation of customized messages regarding a deal. When the consumer purchases a motorcycle at a motorcycle retail store, for example, they may opt to generate a unique message for their closest friends that reads: “Hey People-Let's Roll!” Under this scenario, other peers to which the message conveying the deal data 105 is to be shared may only receive a standard or default message. It is noted that enabling the purchaser to customize the message can facilitate greater buy-in by the customer and peers receiving the message, as the promotion is targeted and leverages the influence of the purchaser.

The deal sharing and configuration module 205 also enables the configuration and execution of user defined rules for regulating how deals are shared with peers and made available to purchasers. As described, this sharing capability is dynamic in that upon completing a transaction, coupon information can be disseminated without delay. By way of example, the consumer may configure their settings such that they are prompted to share deals only when the deal is more than 60% off and if the deal can be made available to at least 3 peers. Some exemplary configuration preferences and settings available to a subscriber—i.e., user of device 101a—by way of the coupon sharing platform 103 are shown in Table 1 below.

TABLE 1
Subscriber based preferences and settings

Subscribers can configure the preferences and thresholds—e.g.,
percentage discounts, only for items costing more than a pre-
determined amount (e.g., $1,000), only electronic items etc.
Subscribers can also create a standard list to share, categorize the
contacts to share the deals with or assign priorities to the contacts
to make the deals available to.
While selecting peers to share with, subscribers can choose by
geographic area of residency. In addition, subscribers can auto-
matically share with only those who are in an eligible
geographic area for participating in the deal. For example, as
some stores operate only in certain states, the deal will only be
allowed to be directed to peers who reside in the appropriate states.
Subscribers can specify their preferred means of communication
of deal data (e.g., SMS, email)

In addition, the deal sharing and configuration module 205 may also enable the establishment of preference settings by the peers for whom deals are to be shared. Under this approach, the deal sharing and configuration module 205 may operate in connection with a deal response activation module 211 for facilitating interaction with the peers in response to a shared deal. Exemplary configuration settings of the peers—i.e., user of devices 101b-101d—are shown in TABLE 2 below.

TABLE 2
Peer based preferences and settings

Peers (e.g., friends and family) can configure the type of the deals
that they receive. For example, they can specify a preferred or
minimum discount percentage, out-of-pocket price of the product
they require, manufacturer's suggested retail price (MSRP) of the
product, product category or any combination thereof.
Peers can comfigure receipt of a deal based on time for expiration
of the deal.
Peers can configure receipt of the deal based on the distance from
home/office locations.
Peers can specify method of communicating the deal data (e.g.,
SMS, email)

The deal sharing and configuration module 205 may also be configured by the retailer/vendor accordingly for ensuring proper execution and management of deals for sharing by purchasers. In addition, the retailer may specify rules for application of incentives and credits for purchasers based on their willingness to share deals with their peers. Exemplary rules and configuration settings of the retailer/vendor—i.e., user of devices 101b-101d—are shown in TABLE 3 below.

TABLE 3
Retailer based preferences and settings

Retailers can configure the number of deals that are available at
any given time, for any given person to share.
Retailers can assign expiration dates/extension of the expiry dates.
Retailers can terminate the available deals at any given time by
notifying the subscribers.
Allow reservation for the deals with an expiry date/time.
Add discounts/cash backs to the subscriber who started the sharing,
up to a certain level.

It is noted that the deal sharing and configuration module 205 affect the type of deal data 105 that is ultimately associated with a given purchaser or peer profile maintained as registration data 217. Only deal data conforming to the configuration settings would be retrieved and subsequently presented.

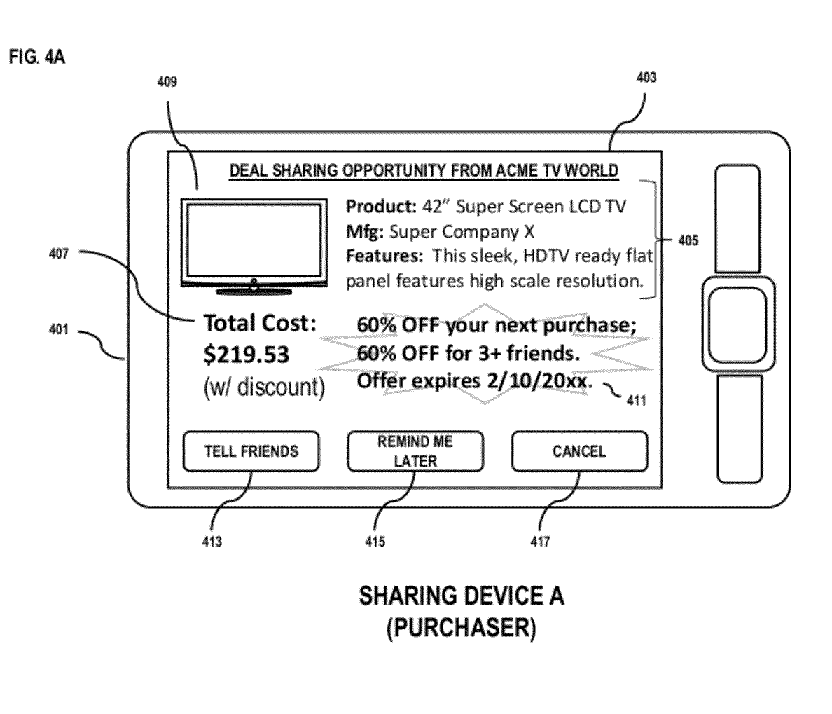

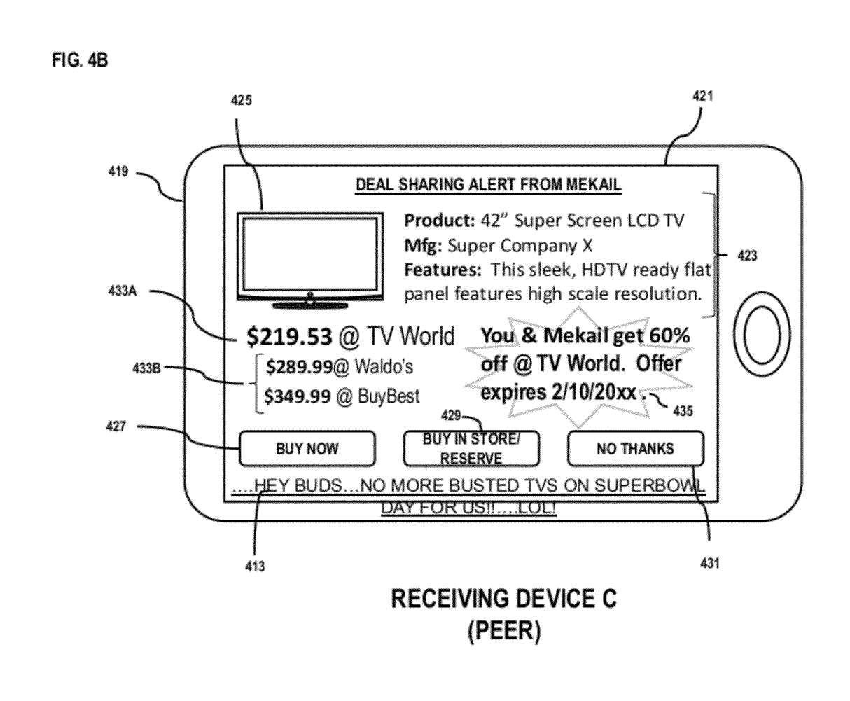

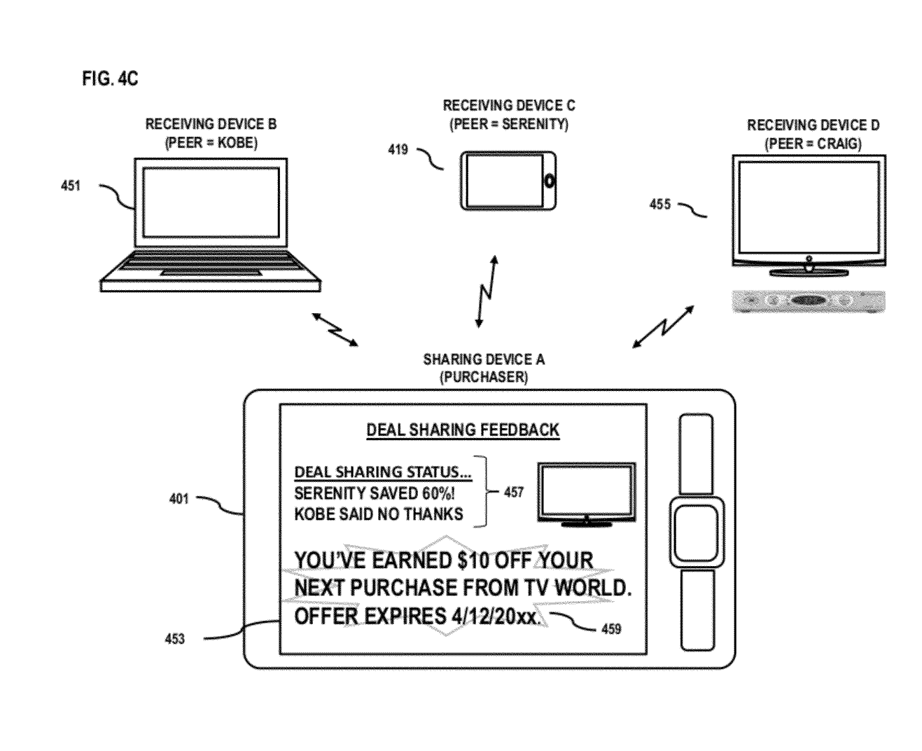

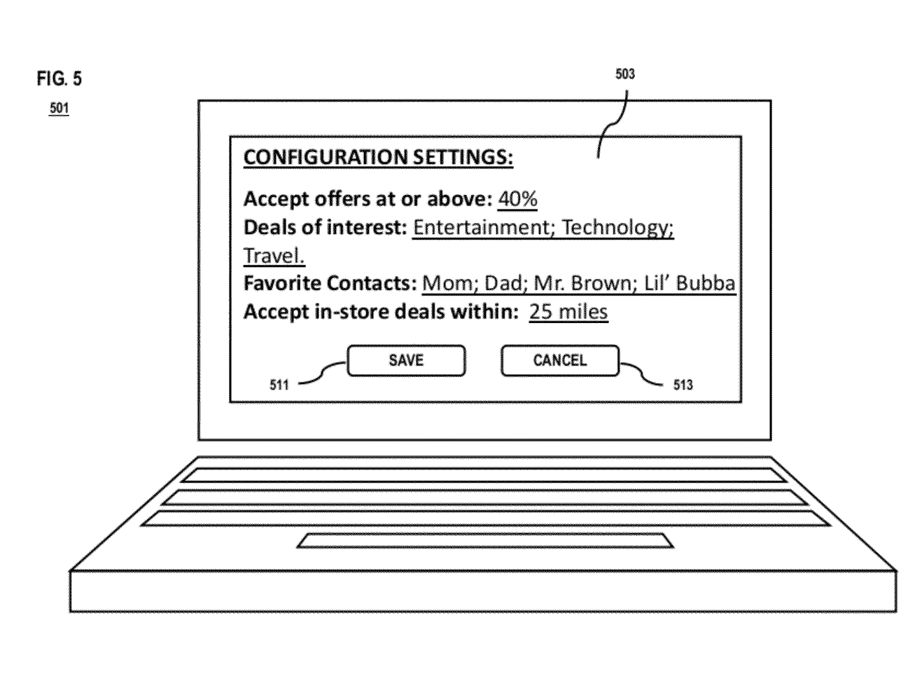

In one embodiment, a deal presentment module 207 operates in connection with the user interface module 215 to enable presentment of deal data, as customized for the specific purchaser and/or peers in accordance with their configuration settings. By way of example, the deal presentment module 207 may cause a message to be generated at the customer's user device, such as for reiterating the details of a purchase transaction (e.g., presentment of a receipt). As another example, the deal presentment module 207 may cause a message to be generated for indicating special offers the purchaser can share with peers. As will be discussed more fully with respect to FIGS. 4A-4C and FIG. 5, purchasers and/or peers may respond to the message by way of various data entry techniques, action buttons or the like.

The deal presentment module 207 also facilitates transmission of messages for conveying the deal to the various peers maintained in queue by the deal sharing and configuration module 205. The transmission process may be performed in conjunction with a communication module 213. Communications among peers may be in the form of a short message service (SMS), multi-media message service (MMS), e-mail or in other instances, a pop-up message; the form of the message may vary depending on the preferences of respective device users. The message provided to the peers will indicate the actual price of the item, discounts received by the referring customer and/or available to them, the location of the store/website, visual or multi-media content (e.g., audio, video), etc. Other details regarding the nature of the deal may also be conveyed, including how long the deal is available, if it is sharable before/after a purchase, the number of users the deal can be shared with, a comparison indicating pricing for the same items across similar retailers, etc. It is noted that the message transmitted to respective user devices 101a-101n may comprise a combination of custom message data and specific deal data 105 pertaining to the retailer, product, purchaser or peers.

In one embodiment, a deal response activation module 211 monitors the responses of the peers selected for sharing of a deal by an initiating customer, including rejection responses, responses indicating interest in the offering, adding of the deal data or product details to a wish list, and responses indicating acceptance of the deal. For example, in response to an indication of interest by the user in the deal, the deal response activation module 211 may cause presentment of a graphical user interface for listing further details and information regarding the product or service of interest. As another example, in response to a request to purchase the product or service of interest, the user may be directed to a POS terminal (e.g., virtual) for facilitating the purchase process.

The deal response activation module 211 may also interact with the deal sharing and configuration module 205 to account for the settings and preferences of the peers. For example, the user may be given the option to adapt how they receive further deal sharing opportunities, including product categories of interest to them, a maximum price limit, etc. Based on these settings, the deal response activation module 211 is able to provide feedback to the deal data retrieval module for affecting future deal data. In another instance, the initiating customer may be restricted from directing a deal to a given contact responsive to a particular setting for that peer.

The deal response activation module 211, in one embodiment, may also be configured to generate feedback messages at the user device 101 about the peers and their responses to the receipt of deal data 105 from the purchaser. By way of example, a feedback message may convey that “Friend A took advantage of the deal,” “that the purchaser is eligible to receive points, credits or other incentives” as a result of the participation of the peers, that “Friend A has no interest,” that “none of the peers responded,” etc. It is noted that the deal response activation module 211 generates these messages for presentment to a user device 101 based on acquired deal response data 219. The deal response data may include statistics regarding the response characteristics of the peers, sharing patterns of the purchaser, a level of influence ranking of the purchaser and other vital data 219 that may be used by the retailer/vendor transaction system 107.

In one embodiment, a controller module 209 is configured to regulate the communication processes between the various other modules. For example, the controller module 209 generates the appropriate signals to control the communication module 213 and deal presentment module 207 for facilitating transmission of data over the service provider network 109. In one embodiment, the communication module 213 also enables formation of a session over the network 109 between the coupon sharing platform 103 and a portal application or web browser configured for execution at a user interface of a device 101a-101n. By way of example, the communication module 213 executes various protocols and data sharing techniques for enabling collaborative execution between a user device 101a-101n (e.g., mobile devices, laptops, smartphones, tablet computers, desktop computers) and the coupon sharing platform 103 over the service provider network 109.

It is noted that the communication module 213 may also be configured to exchange data with the retailer/vendor transaction system 107, such as in connection with the deal retrieval module 203 for retrieving deal data. In addition, the communication module 213 may also be configured to periodically send the deal response data as generated by the deal response activation module 211 to the retailer/vendor transaction system 107. By way of this approach, the deal response data may be analyzed by the retailer/vendor for generating reports or for providing intelligence that enables refinement of deal data 105, sales strategies, target marketing efforts and product offerings (e.g., elimination of unpopular deals and products). The deal response data may also be used to identify top sharing users—i.e., those whose sharing of deals results in the most purchase activity amongst their social network. Under this approach, the retailer may configure deal data specific to such users for enabling presentment of more deals or more incentives as a means of generating more purchase transaction activity. It is noted that the deal response tendencies and patterns exhibited by respective purchasers and peers—i.e., deal respond data 219—may prove useful for facilitating development of larger scale television (TV), radio and media campaigns.

As mentioned above, in one embodiment the user interface module 215 enables presentment of a graphical user interface of a customer computing device. By way of example, the user interface module 215 generates a user interface in response to application programming interfaces (APIs) or other function calls corresponding to the web browser or web portal application of the user device 101 for enabling display of graphical and textual elements. It is noted the user interface is generated at the purchaser's user device 101a to enable viewing of deal data 105 pursuant to execution of a purchase transaction with a retailer. Also, the user interface is configured to present the purchaser with various options for sharing deals with select peers. Similarly, the user interface of the peer devices 101b-101d are configured to receive deal data 105 and respond to offers or provide feedback.

Of note, the above described modules 201-215 may also perform similarly described functions in connection with a retailer/vendor subscribed to or associated with the coupon sharing platform 103 by way of the service provider. For example, the authentication module 201 may perform various functions for authenticating retailers, vendors and service providers wishing to publish deal data 105. As another example, the communication module 213 and user interface module 215 may be configured by a retailer for enabling specific content (e.g., retailer specific logos, color schemes, brand materials, barcodes, etc.) to be transmitted and presented to a user device 101. This content may be maintained as deal data 105 accordingly. In another example, the deal response activation module 211 may be configured by a retailer to generate reports based on collected deal response data (e.g., metrics, forecasts and other intelligence for indicating the effectiveness of deal data, marketing approaches, etc.) Ultimately, the coupon sharing platform 103 enables proper execution, management and sharing of deals with respect to all parties to a transaction, including purchasers, peers and retailers.

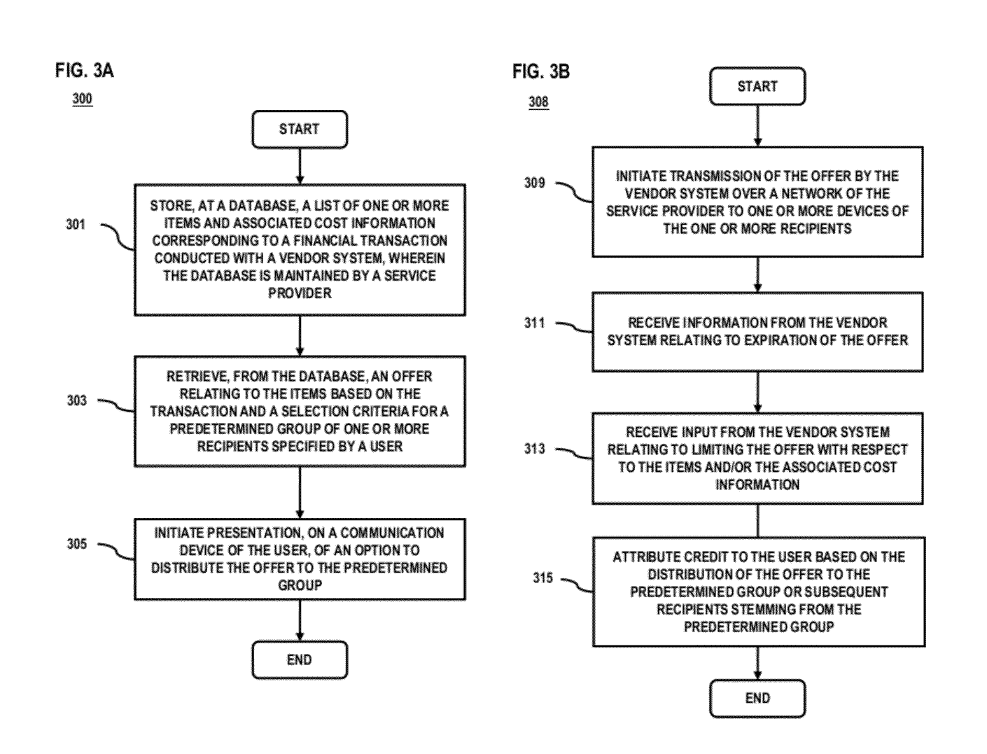

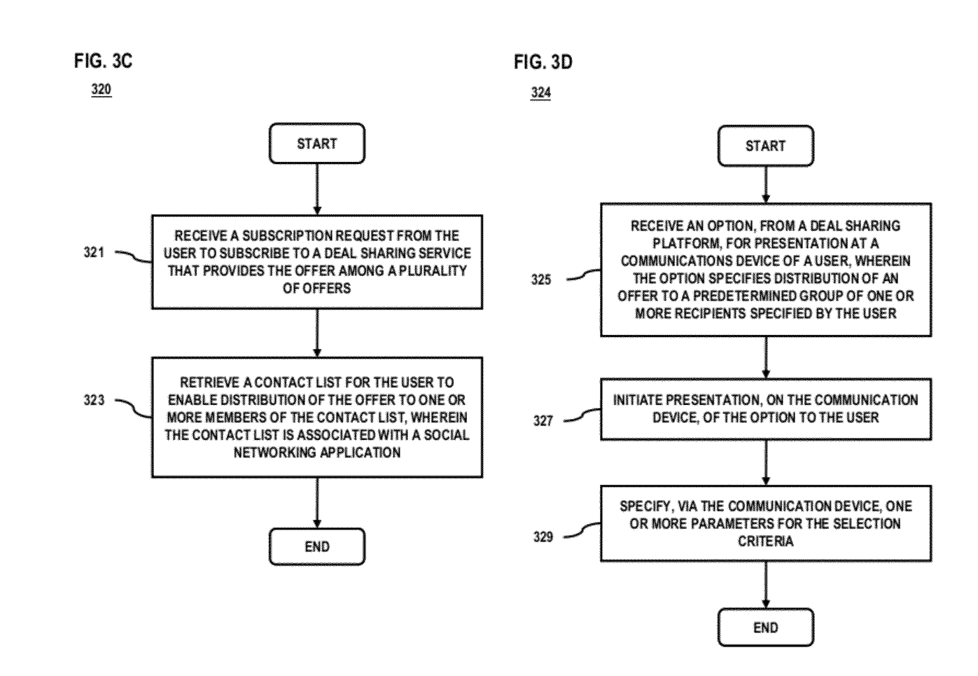

FIGS. 3A-3D are flowcharts of a process for directly sharing offers with peers, according to various embodiments. For the purpose of illustration, the processes are described with respect to FIG. 1. It is noted that the steps of the process may be performed in any suitable order, as well as combined or separated in any suitable manner. In step 301 of process 300, the coupon sharing platform 103 stores a list of one or more items and associated cost information (e.g., pricing data) corresponding to a financial transaction conducted with a vendor system (e.g., retailer/vendor transaction system 107). As mentioned, the one or more items and associated cost information may be maintained as deal data 105 at the coupon sharing platform 103 by the service provider. In step 303, an offer is retrieved from the deal database 105 that relates to the items based on the transaction and a selection criteria for a predetermined group of one or more recipients (peers) specified by a user (initiating purchaser). By way of example, the retrieval process may be triggered by interaction on the part of the user (purchaser) with a POS terminal 107a of the retailer/vendor.

In another step 305, the coupon sharing platform 103 initiates presentation, on a communication device 101a of the user (purchaser), of an option to distribute the offer to the predetermined group (including one or more peers). As noted above, the option may include various action buttons or data entry fields for enabling the user to respond appropriately to the option, and thus enable direct interaction between the communication device 101a and the coupon sharing platform 103.

Per step 309 of process 308 of FIG. 3B, the coupon sharing platform 103 initiates transmission of the offer by the vendor system 107 over a network 109 of the service provider to one or more devices 101b-101d of the one or more recipients. The offer includes the cost information, and is furthermore transmitted in a preferred form of the one or more recipients. In steps 311 and 313, the coupon sharing platform 103 receives information from the vendor system 107 relating to expiration of the offer as well as input from the vendor system 107 relating to limiting the offer with respect to the items and/or the associated cost information. As mentioned previously, this pertains to configuration settings, rules and controls established by the retailer/vendor for enabling effective management, distribution and monitoring of deals via the coupon sharing platform 103. In another step 315, the coupon sharing platform 103 may act in conjunction with the vendor system 107 to attribute credit to the user based on the distribution of the offer to the predetermined group or subsequent recipients stemming from the predetermined group.

In step 321 of process 320 of FIG. 3C, the coupon sharing platform 103 receives a subscription request from the user to subscribe to a deal sharing service that provides the offer among a plurality of offers. As mentioned, the deal sharing service is made available by a service provider in connection with one or more retailers/vendors. In another step 323, the coupon sharing platform may be configured to retrieve a contact list for the user to enable distribution of the offer to one or more members of the contact list. The contact list may be associated with a social networking application or contact management application of the device 101.

In FIG. 3D, for step 325 of process 324, the purchaser receives an option from the coupon sharing platform 103 specifying distribution of an offer to a predetermined group of peers. As noted, this option is presented pursuant to or as part of a purchase transaction process engaged by the purchaser with the vendor. Per step 327, the coupon sharing platform 103 initiates presentation of the option to the user by way of their user device 101a. In another step 329, the purchaser specifies one or more parameters for the selection criteria by way of the user device 101a. The selection criteria may include discount percentage, price paid by the user of the one or more items, retail price of the one or more items, product category, location of a store that supplies the one or more items, or a combination thereof. It is noted that the selection criteria may enable refinement or restriction of offers made by the coupon sharing platform 103 to a user or respective peers on the vendor/retailers behalf.

FIGS. 4A-4C are diagrams of a user interface for enabling device users to direct and receive retail offers among peers based on a recent purchase transaction, according to various embodiments. For the purpose of illustration, the diagrams are described with respect to an exemplary use case of a subscriber to the deal sharing service interacting with one or more peers with regards to a purchase transaction the subscriber engaged. It is noted that while the user interface depictions correspond to the process of deal sharing and receiving, the devices may be configured to cause presentment of various additional screens based on interaction of devices with the coupon sharing platform 103. As mentioned, such presentment can be in form of the scanning of a bar code to activate the particular deal.

In FIG. 4A, a purchaser of a product, good or service of a retailer receives a deal sharing opportunity at their user device 401 (sharing device A). The deal sharing opportunity is presented to the user interface 403 of the device 401 for specifying details regarding the recent purchase 405 made by the purchaser from the retailer ACME TV World, cost information 407 associated with the purchase, a picture 409 representative of the product, good or service, deals 411 available for the purchaser or peers associated with the purchaser and one or more action buttons 413-417 for enabling the user to respond to the deal sharing opportunity. The action buttons may include a “Tell Friends” button 413 for enabling the purchaser to share the deal opportunity, a “Remind Me Later” button 415 for enabling a reminder about the deal sharing opportunity at a later time and a “Cancel” button 417 for disregarding the deal sharing opportunity.

By way of example, when the user purchases a television from ACME TV World, the user may activate the “Tell Friend” button 413 to initiate sharing of the offer (60% off for 3+ friends). Upon selection of the action button 413, the user interface 403 may present a contact management application or social networking application for enabling user selection of friends, family, co-workers or other peers that they want to share the deal with. Alternatively, the friends may already be predetermined, such that activation of the “Tell Friends” action button 413 results in presentment of a confirmation message (not shown) to the sharing device 401 for indicating that the deal was sent to the selected peers. In certain embodiments, it is contemplated that the purchaser may also be provided a message customization interface (not shown) for enabling the generation of customized messages for one or more of the peers to which the deal sharing opportunity is to be directed.

In FIG. 4B, a peer selected by the purchaser receives a deal sharing alert by way of their user device 419. For the purpose of illustration, the recipient's device is labeled as a receiving device C, while the other devices configured by respective peers are receiving devices B and D. By way of example, the deal sharing alert from the purchaser includes details regarding the recent purchase 423 made by the purchaser from the retailer ACME TV World, cost information 433a associated with the purchase along with comparison cost FIG. 433b for other vendors and retailers who offer the same product, good or service, a picture 425 representative of the product, good or service, details regarding the deal 435 being offered to the receiving peer (e.g., discounts, incentives, offer expiration date), a customized message 413 as generated by the purchaser for presentment to one or more of the peers, and one or more action buttons 427-431 for enabling the peer to respond to the deal sharing opportunity. For the purpose of illustration, the custom message 413 is presented to the interface 421 of the device 419 as a scrolling or marquee message.

The action buttons available to the peer include a “Buy Now” button 427 for enabling the peer to purchase the product, good or service. Upon activation of this button 427, a purchase transaction screen (not shown) may be presented to the user interface 421, such as for enabling the input of credit card information, billing address data and other data for facilitating a purchase transaction between the receiving peer and the retailer. A “Buy In Store/Reserve” button 429 may also be featured for enabling the user to reserve the product for pickup and subsequent purchase at a store location, i.e., the nearest TV World within proximity of the peer's current location, home and/or office address. Action button 429 may also enable the user to reserve the shared deal (e.g., offer or coupon) for later use, subject to a predetermined expiry date. Under this scenario, the user may recall the deal sharing opportunity at a time of their convenience. In instances where the peer is not interested in the deal sharing offer, they may activate the “No Thanks” button 431 in order to disregard the deal sharing opportunity.

In FIG. 4C, the purchaser operating the sharing device receives feedback regarding the deal sharing opportunities directed to respective peers. As mentioned, the peers who received the deal sharing opportunity operate devices 451, 419 and 455 respectively, corresponding to a laptop computer, smartphone and set-top box/TV. It is noted that any device for enabling presentment of data, including textual, graphical, audio or multi-media, may be suitably configured by peers to enable receipt of deals.

By way of example, having directed the deal sharing opportunity to peers Kobe, Serenity and Craig, a deal sharing feedback interface 453 is presented to the purchaser's device 401. The deal sharing presents information including a deal sharing status 457 for indicating which of the peers did or did not take advantage of the deal and an incentive message 459 for indicating any incentives, credits or discounts earned by the purchaser as a result of them sharing the deal with peers. Under this scenario, Serenity took advantage of the offer while Kobe declined. No status feedback is available yet for Craig, which may indicate that he has yet to respond to or receive the message. Responsive to the feedback, the coupon sharing platform 103 in conjunction with the retailer presents an incentive message 459 indicating that the purchaser earned $10 off their next purchase. It is noted that the incentive may correspond to an incentive program that was prearranged between the retailer and the purchase, or alternatively, generated dynamically for presentment to the user by the coupon sharing platform in response to retailer analysis of deal response data.

It is noted, with respect to the above presented examples, that deal sharing opportunities (e.g., coupons) may be associated to the particular user so it can be tracked if it is used or is applied with respect to predetermined criteria. For example, if a deal sharing opportunity must be shared with five peers to enable the referring user to receive an incentive, the platform 103 will track usage of the peers. If the user shares a deal with ten peers, only the first 5 will get the coupon, whereas the remaining get a notice stating that the coupon shared by Mr. X is unavailable (e.g., “Five friend limit has been met. Sorry!”). Alternatively, if the first five friends use the coupon, the remaining friends may be notified that the coupon is no longer available for use as the deal has already been executed or reserved by others. The reservation may expire ahead of time—ahead of the coupon expiry in which case the deal may become available for other users who wanted to use it but found it was reserved.

FIG. 5 is a diagram of a user interface for configuring a device to direct or receive retail offers among peers based on a purchase transaction, according to one embodiment. The user interface may include various data entry fields, action buttons and other data selection features for enabling purchasers, peers or retailers to configure their deal sharing, receipt or generation settings. For the purpose of illustration, the user interface 513 is presented from the perspective of configuration settings for a purchaser or peer. It is noted, however, that the configuration settings for a retailer or vendor may be similarly provided by the coupon sharing platform 103, i.e., with features corresponding to TABLE 3 above.

By way of example, the configuration settings interface 503 of the computing device 501 includes data entry fields for enabling the user to establish a percentage range at which they will accept offers at or above, categories for indicating deal types of interest (e.g., entertainment related deals, technology related deals, travel related deals, home and office related deals), favorite contacts for sharing deals with, a distance setting for acceptance of in-store only deals. Other configuration settings may also include parameters for indicating a preferred means of communication and presentment of messages (e.g., SMS, MMS, e-mail), vendor system/POS terminal communication settings, settings for prioritizing peers to be contacted, etc. In addition, one or more action buttons 511 and 513 may be provided for enabling the user to save or cancel the settings. It is noted that the configuration settings interface 503 may also present an option for enabling the user to modify their profile information, which includes their primary address, phone number of the user device, service provider information and other data for characterizing the user device 101 and/or the user.

The exemplary techniques and systems presented herein enables service providers, retailers, and subscribers to interact dynamically based on execution of a purchase transaction. By way example, a device user may readily share deals and incentives offered by retailers at the time of purchase with their friends, thus integrating social networking as natural function of the sales or purchase transaction process. Notably, platform 103 enables service providers, retailers, and subscribers to configure deal sharing parameters (outbound and inbound, e.g., sending and receiving of deals/coupons). Also, subscribers and peers can manage their purchase coupon settings from heterogeneous devices (e.g., mobile phone, personal computer (PC) browser, interactive television set, etc.) including deal/coupon transaction history. In addition, system 100 provides a capability for the retailer/vendor transaction system 107 to interact with user devices 101a-101n for presenting itemized receipts along with eligible, sharable deal details. Platform 103 can also permit retailers to set thresholds and limits for transferring, configuring or generating deals (e.g., option to terminate deal at anytime for maintaining a controlled viral campaign). Furthermore, the service provider can provide, via the dynamic coupon sharing platform 103, an affiliated retailer with real-time reports specifying the number of deals/coupons shared, to what recipients, when deals were shared and accepted, and the location of recipients.

In certain embodiments, the described processes and arrangement provide numerous advantages, including providing a new source of revenue for the service provider, while saving money for consumers.

The processes described herein for providing dynamic coupon sharing may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

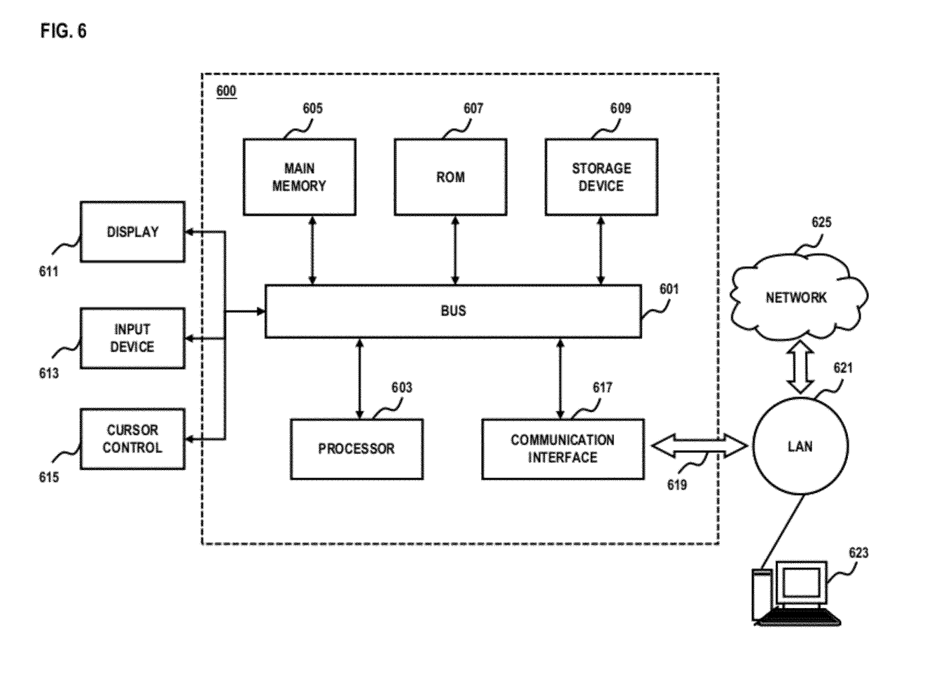

FIG. 6 is a diagram of a computer system that can be used to implement various exemplary embodiments. The computer system 600 includes a bus 601 or other communication mechanism for communicating information and one or more processors (of which one is shown) 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for adjusting cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

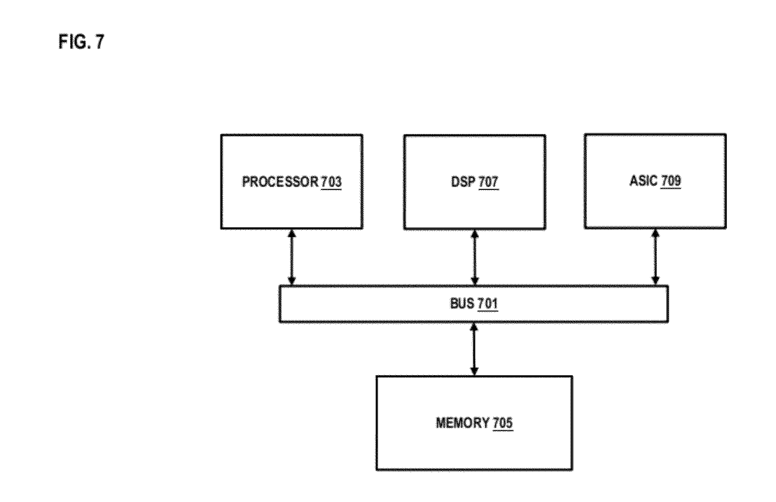

FIG. 7 illustrates a chip set or chip 700 upon which an embodiment of the invention may be implemented. Chip set 700 is programmed to enable a purchaser to immediately direct retail offers to peers within their social network based on a purchase transaction as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of enabling a purchaser to dynamically direct retail offers to peers within their social network based on a purchase transaction.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enable a purchaser to immediately direct retail offers to peers within their social network based on a purchase transaction. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
storing, at a database, a list of one or more items and associated cost information corresponding to a financial transaction conducted with a vendor system, wherein the database is maintained by a service provider;
retrieving, from the database, an offer relating to the items based on the transaction and a selection criteria for a predetermined group of one or more recipients specified by a user; and
initiating presentation, on a communication device of the user, of an option to distribute the offer to the predetermined group.

2. A method according to claim 1, further comprising:
initiating transmission of the offer by the vendor system over a network of the service provider to one or more devices of the one or more recipients, wherein the offer includes the cost information.

3. A method according to claim 2, further comprising:
determining an identifier associated with establishment of communications with the user over the network; and
generating an authentication key for the offer based on the determined identifier.

4. A method according to claim 1, further comprising:
receiving information from the vendor system relating to expiration of the offer.

5. A method according to claim 1, wherein the offer is generated by the vendor system, the method further comprising:
receiving input from the vendor system relating to limiting the offer with respect to the items and/or the associated cost information.

6. A method according to claim 1, further comprising:
attributing credit to the user based on the distribution of the offer to the predetermined group or subsequent recipients stemming from the predetermined group.

7. A method according to claim 1, wherein the selection criteria include discount percentage, price paid by the user of the one or more items, retail price of the one or more items, product category, location of a store that supplies the one or more items, or a combination thereof.

8. A method according to claim 1, further comprising:
receiving a subscription request from the user to subscribe to a deal sharing service that provides the offer among a plurality of offers.

9. A method according to claim 1, further comprising:
retrieving a contact list for the user to enable distribution of the offer to one or more members of the contact list.

10. An apparatus comprising:
at least one processor; and
at least one memory including computer program code for one or more programs,
the at least one memory and the computer program code configured to, with the at least one processor, cause the apparatus to perform at least the following,
store, at a database, a list of one or more items and associated cost information corresponding to a financial transaction conducted with a vendor system, wherein the database is maintained by a service provider,
retrieve, from the database, an offer relating to the items based on the transaction and a selection criteria for a predetermined group of one or more recipients specified by a user, and
initiate presentation, on a communication device of the user, of an option to distribute the offer to the predetermined group.

11. An apparatus according to claim 10, wherein the apparatus is further caused to:
initiate transmission of the offer by the vendor system over a network of the service provider to one or more devices of the one or more recipients, wherein the offer includes the cost information.

12. An apparatus according to claim 11, wherein the apparatus is further caused to:
determine an identifier associated with establishment of communications with the user over the network; and
generate an authentication key for the offer based on the determined identifier.

13. An apparatus according to claim 10, wherein the apparatus is further caused to:
receive information from the vendor system relating to expiration of the offer.

14. An apparatus according to claim 10, wherein the offer is generated by the vendor system, and the apparatus is further caused to:
receive input from the vendor system relating to limiting the offer with respect to the items and/or the associated cost information.

15. An apparatus according to claim 10, wherein the apparatus is further caused to:
attribute credit to the user based on the distribution of the offer to the predetermined group or subsequent recipients stemming from the predetermined group.

16. An apparatus according to claim 10, wherein the selection criteria include discount percentage, price paid by the user of the one or more items, retail price of the one or more items, product category, location of a store that supplies the one or more items, or a combination thereof.

17. An apparatus according to claim 10, wherein the apparatus is further caused to:
receive a subscription request from the user to subscribe to a deal sharing service that provides the offer among a plurality of offers.

18. An apparatus according to claim 10, wherein the apparatus is further caused to:
retrieve a contact list for the user to enable distribution of the offer to one or more members of the contact list.

19. A method comprising:
receiving an option, from a deal sharing platform, for presentation at a communications device of a user, wherein the option specifies distribution of an offer to a predetermined group of one or more recipients specified by the user, the offer relating to one or more items purchased in a financial transaction conducted with a vendor, the offer being generated based on a selection criteria; and
initiating presentation, on the communication device, of the option to the user.

20. A method according to claim 19, wherein the deal sharing platform is maintained by a service provider, and the offer is initiated by the vendor system via the deal sharing platform, the method further comprising:
specifying, via the communication device, one or more parameters for the selection criteria, wherein the selection criteria include discount percentage, price paid by the user of the one or more items, retail price of the one or more items, product category, location of a store that supplies the one or more items, or a combination thereof.
